(19) United States
(12) Patent Application Publication
(10) Pub. No.: US 2022/0066280 A1
(43) Pub. Date: Mar. 3, 2022

(54) OPTICAL MODULATOR

(71) Applicant: SUMITOMO ELECTRIC INDUSTRIES, LTD., Osaka (JP)

(72) Inventor: Naoya KONO, Osaka-shi (JP)

(73) Assignee: SUMITOMO ELECTRIC INDUSTRIES, LTD., Osaka (JP)

(21) Appl. No.: 17/375,259

(22) Filed: Jul. 14, 2021

(30) Foreign Application Priority Data
Aug. 25, 2020 (JP) 2020-141668

(51) Int. Cl. G02F 1/225; G02F 1/21; H01L 21/302; H01L 21/04

(52) U.S. Cl. CPC G02F 1/2257; G02F 1/212; G02F 2201/12; H01L 21/0455; H01L 21/302

(57) ABSTRACT

An optical modulator includes a first mesa waveguide and a second mesa waveguide. Each of the first mesa waveguide and the second mesa waveguide includes a first semiconductor layer that has a p-type conductivity and is provided on a substrate, a second semiconductor layer that has a p-type conductivity and is provided on the first semiconductor layer, a core layer provided on the second semiconductor layer, and a third semiconductor layer that has an n-type conductivity and is provided on the core layer. The first semiconductor layer has a dopant concentration greater than a dopant concentration in the second semiconductor layer.

### CROSS REFERENCE TO RELATED APPLICATIONS

The present application is based upon and claims the benefit of the priority from Japanese patent application No. 2020-141668, filed on Aug. 25, 2020, which is hereby incorporated by reference in its entirety.

### TECHNICAL FIELD

The present disclosure relates to an optical modulator.

### BACKGROUND

Patent Document 1 (U.S. Patent Application Publication No. 2013/0209023) discloses a Mach-Zehnder modulator which includes two mesa waveguides provided on a semi-insulating substrate. Each of the mesa waveguides has a p-i-n structure. That is, each of the mesa waveguides includes an n-type semiconductor layer, an i-type semiconductor layer, and a p-type semiconductor layer which are provided in order on the semi-insulating substrate.

### SUMMARY

The present disclosure provides an optical modulator including a first mesa waveguide and a second mesa waveguide. Each of the first mesa waveguide and the second mesa waveguide includes a first semiconductor layer that has a p-type conductivity and is provided on a substrate, a second semiconductor layer that has a p-type conductivity and is provided on the first semiconductor layer, a core layer provided on the second semiconductor layer, and a third semiconductor layer that has an n-type conductivity and is provided on the core layer. The first semiconductor layer has a dopant concentration greater than a dopant concentration in the second semiconductor layer.

### BRIEF DESCRIPTION OF THE DRAWINGS

The foregoing and other purposes, aspects and advantages will be better understood from the following detailed description of a preferred embodiment of the invention with reference to the drawings.

FIG. 1 is a plan view schematically illustrating an optical modulator according to a first embodiment.

FIG. 2 is a cross-sectional view taken along line II-II in FIG. 1.

FIG. 3 is a cross-sectional view taken along line III-III in FIG. 1.

FIG. 4 is a graphical representation of an exemplary relation between frequency and electro-optical (EO) response.

FIG. 5 is a graphical representation of an exemplary relation between lower cladding layer and optical transmission loss.

FIG. 6A is a cross-sectional view schematically illustrating a step in a method of manufacturing the optical modulator according to the first embodiment.

FIG. 6B is a cross-sectional view schematically illustrating a step in a method of manufacturing the optical modulator according to the first embodiment.

FIG. 6C is a cross-sectional view schematically illustrating a step in a method of manufacturing the optical modulator according to the first embodiment.

FIG. 7 is a cross-sectional view schematically illustrating a part of an optical modulator according to a second embodiment.

### DETAILED DESCRIPTION

In a mesa waveguide having a p-i-n structure, an n-type semiconductor layer of a first mesa waveguide and an n-type semiconductor layer of a second mesa waveguide are electrically connected to each other via a conductive layer. On the other hand, since a p-type semiconductor layer is located at a top portion of each mesa waveguide, it is difficult to widen the p-type semiconductor layer to reduce a resistance value of the p-type semiconductor layer. In addition, a resistivity of a semiconductor material forming the p-type semiconductor layer is usually larger than a resistivity of a semiconductor material forming the n-type semiconductor layer. Therefore, it is difficult to reduce a resistance value of the mesa waveguide having the p-i-n structure.

Therefore, it is conceivable to use a mesa waveguide having an n-i-p structure instead of the mesa waveguide having the p-i-n structure. The mesa waveguide with the n-i-p structure includes the p-type semiconductor layer, the i-type semiconductor layer and the n-type semiconductor layer which are provided in order on the semi-insulating substrate. In order to reduce the resistance value of the p-type semiconductor layer, it is considered to increase a dopant concentration in the p-type semiconductor layer. However, since an optical absorption coefficient of the p-type semiconductor layer becomes larger, a transmission loss of light propagating through the i-type semiconductor layer, which is a core layer, increases.

The present disclosure provides the optical modulator that can reduce the transmission loss of light propagating through the core layer while reducing the resistance value of the mesa waveguide.

### Description of Embodiments of the Present Disclosure

An optical modulator according to an embodiment includes a first mesa waveguide and a second mesa waveguide. Each of the first mesa waveguide and the second mesa waveguide includes a first semiconductor layer that has a p-type conductivity and is provided on a substrate, a second semiconductor layer that has a p-type conductivity and is provided on the first semiconductor layer, a core layer provided on the second semiconductor layer, and a third semiconductor layer that has an n-type conductivity and is provided on the core layer. The first semiconductor layer has a dopant concentration greater than a dopant concentration in the second semiconductor layer.

According to the above optical modulator, since the first semiconductor layer has a resistance value smaller than a resistance value of the second semiconductor layer, a total resistance value of the first semiconductor layer and the second semiconductor layer can be reduced as compared with a case where the first semiconductor layer is not present. On the other hand, since the second semiconductor layer has an optical absorption coefficient smaller than an optical absorption coefficient of the first semiconductor layer, a transmission loss of light propagating through a core layer can be reduced as compared with a case where the second semiconductor layer is not present. Therefore, according to the above-mentioned optical modulator, it is possible to reduce the transmission loss of light propagating through the core layer while reducing the resistance value of the mesa waveguide.

The first semiconductor layer of the first mesa waveguide and the first semiconductor layer of the second mesa waveguide may be connected to each other. This allows the first mesa waveguide and the second mesa waveguide to be electrically connected to each other.

Each of the first mesa waveguide and the second mesa waveguide may further include a barrier layer provided between the substrate and the first semiconductor layer. The barrier layer may prevent a dopant contained in the first semiconductor layer from diffusing into the substrate. In this instance, it is possible to suppress a decrease in the dopant concentration of the first semiconductor layer.

The substrate may be a semi-insulating semiconductor substrate. The barrier layer may prevent a dopant contained in the substrate from diffusing into the first semiconductor layer. In this case, it is possible to suppress a decrease in the dopant concentration of the substrate.

The first semiconductor layer may include InGaAs. In this case, the dopant concentration of the first semiconductor layer can be increased as compared with the case where the first semiconductor layer includes InP.

### Details of Embodiments of the Present Disclosure

Hereinafter, embodiments according to the present disclosure will be described in detail with reference to the drawings. In the description of the drawings, like or corresponding elements are denoted by like reference numerals and redundant descriptions thereof will be omitted. An X-axis direction, a Y-axis direction and a Z-axis direction that intersect each other are indicated in the drawings as required. The X-axis direction, the Y-axis direction and the Z-axis direction are perpendicular to each other, for example.

### First Embodiment

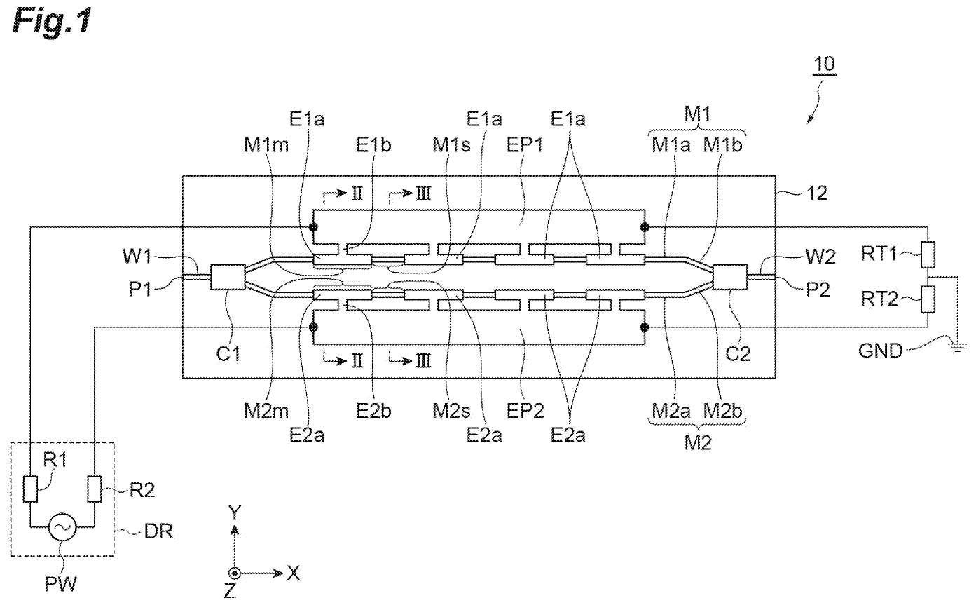

FIG. 1 is a plan view schematically illustrating an optical modulator according to a first embodiment. An optical modulator 10 illustrated in FIG. 1 is a Mach-Zehnder modulator, for example. For example, optical modulator 10 can modulate an intensity or a phase of light in optical communications to generate modulation signals. Optical modulator 10 can attenuate light by adjusting the intensity of light, for example.

Optical modulator 10 includes a first mesa waveguide M1 and a second mesa waveguide M2. First mesa waveguide M1 and second mesa waveguide M2 are a first arm waveguide and a second arm waveguide of Mach-Zehnder modulator, respectively. Each of first mesa waveguide M1 and second mesa waveguide M2 is provided on a substrate 12 so as to extend in the X-axis direction and has a height in the Z-axis direction.

An input end of first mesa waveguide M1 and an input end of second mesa waveguide M2 are optically coupled to an optical demultiplexer C1. Optical demultiplexer C1 is a multi-mode interference (MMI) coupler such as a 1×2 multi-mode interference coupler, for example. Optical demultiplexer C1 is optically coupled to an output end of an input waveguide W1. An input end of an input waveguide W1 is an input port P1. Input port P1 is located on an edge portion of substrate 12. A light enters input port P1.

An output end of first mesa waveguide M1 and an output end of second mesa waveguide M2 are optically coupled to optical multiplexer C2. Optical multiplexer C2 is an MMI coupler such as a 2×1 multi-mode interference coupler. Optical multiplexer C2 is optically coupled to an input end of output waveguide W2. An output end of output waveguide W2 is an output port P2. Output port P2 is located on an edge portion opposite to the edge portion of substrate 12 where input port P1 is located. A light is emitted from output port P2.

First mesa waveguide M1 includes a straight waveguide M1 a extending in the X-axis direction, and a pair of first and second bent waveguides M1b. Each of the first and second bent waveguides M1b is optically coupled to a corresponding end of straight waveguide M1a. First bent waveguide M1b is optically coupled to optical demultiplexer C1. Second bent waveguide M1b is optically coupled to optical multiplexer C2. Straight waveguide M1a includes a plurality of modulation portions M1m disposed apart from each other in the X-axis direction. Insulating portions M1s are located between the plurality of modulation portions M1m. Conductive lines E1a extending in the X-axis direction are connected to each of modulation portions M1m. Conductive lines E1a are located on modulation portions M1m. Each of conductive lines E1a is connected to an electrode pad EP1 by a conductive line E1b. Electrode pad EP1 is located away from conductive line E1a in the Y-axis direction. Electrode pad EP1 extends in the X-axis direction over the plurality of modulation portions M1m. Conductive line E1a, conductive line E1b and electrode pad EP1 are located above substrate 12. Conductive line E1a, conductive line E1b and electrode pad EP1 include metals such as gold, for example.

Second mesa waveguide M2 has the same configuration as first mesa waveguide M1. Second mesa waveguide M2 includes a straight waveguide M2a in the X-axis direction, and a pair of first and second bent waveguides M2b. Each of the first and second bent waveguides M2b is optically coupled to a corresponding end of straight waveguide M2a. First bent waveguide M2b is optically coupled to optical demultiplexer C1. Second bent waveguide M2b is optically coupled to optical multiplexer C2. Straight waveguide M2a includes a plurality of modulation portions M2m disposed apart from each other in the X-axis direction. Insulating portions M2s are located between the plurality of modulation portions M2m. Conductive lines E2a extending in the X-axis direction are connected to each of modulation portions M2m. Conductive lines E2a are located on modulation portions M2m. Each of conductive lines E2a is connected to an electrode pad EP2 by a conductive line E2b. Electrode pad EP2 is located away from conductive line E2a in the Y-axis direction. Electrode pad EP2 extends in the X-axis direction over the plurality of modulation portions M2m. Conductive line E2a, conductive line E2b and electrode pad EP2 are located above substrate 12. Conductive line E2a, conductive line E2b and electrode pad EP2 include metals such as gold, for example.

A driver circuit DR is connected to one end of electrode pad EP1 and one end of electrode pad EP2 by conductive lines. Driver circuit DR includes an alternating current power supply PW, a resistive element R1, and a resistive element R2. Alternating current power supply PW is connected to the one end of electrode pad EP1 via resistive element R1 by the conductive line. Alternating current power supply PW is connected to the one end of electrode pad EP2 via resistive element R2 by the conductive line.

The other end of electrode pad EP1 is connected to a ground potential GND via a terminator RT1 by a conductive line. The other end of electrode pad EP2 is connected to a ground potential GND via a terminator RT2 by a conductive line.

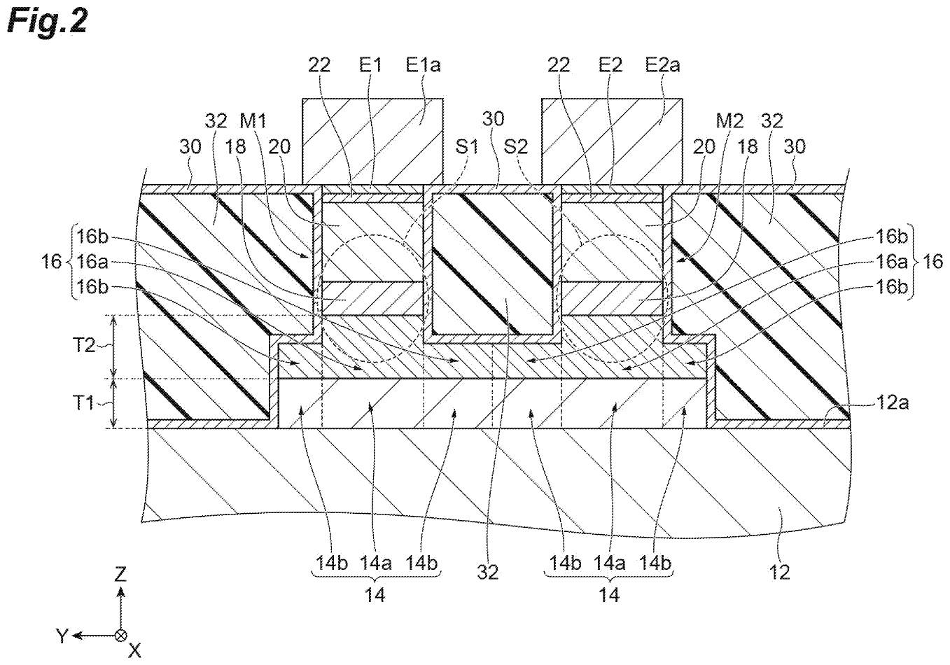

FIG. 2 is a cross-sectional view taken along line II-II in FIG. 1. FIG. 2 illustrates cross-sections of modulation portions M1m and modulation portions M2m. As illustrated in FIG. 2, each of first mesa waveguide M1 and second mesa waveguide M2 includes a p-type first semiconductor layer 14 provided on substrate 12, a p-type second semiconductor layer 16 provided on first semiconductor layer 14, a core layer 18 provided on second semiconductor layer 16, and an n-type third semiconductor layer 20 provided on core layer 18. First semiconductor layer 14, second semiconductor layer 16, core layer 18, and third semiconductor layer 20 are provided in order on a main surface 12a of substrate 12. Second semiconductor layer 16 forms a lower cladding layer. Third semiconductor layer 20 forms an upper cladding layer. Core layer 18 of first mesa waveguide M1 and core layer 18 of second mesa waveguide M2 are disposed apart from each other in the Y-axis direction. In a cross-section of first mesa waveguide M1 perpendicular to the X-axis direction, a spot 51 of light is formed over second semiconductor layer 16, core layer 18, and third semiconductor layer 20. In a cross-section of second mesa waveguide M2 perpendicular to the X-axis direction, a spot S2 of light is formed over second semiconductor layer 16, core layer 18, and third semiconductor layer 20.

Substrate 12 is a semi-insulating semiconductor substrate, for example. Substrate 12 includes a III-V group compound semiconductor doped with an insulating dopant. Substrate 12 includes iron (Fe)-doped InP, for example. A dopant concentration of substrate 12 may be 1×10¹⁷ cm⁻³ or more and 1×10¹⁸ cm⁻³ or less.

First semiconductor layer 14 includes a first portion 14a and a pair of second portions 14b. First portion 14a is located between core layer 18 and substrate 12. Each of the pair of second portions 14b is located on each side of first portion 14a. First portion 14a and the pair of second portions 14b extend in the X-axis direction. Therefore, a width of first semiconductor layer 14 (a length in the Y-axis direction), is larger than a width of core layer 18. First semiconductor layer 14 of first mesa waveguide M1 and first semiconductor layer 14 of second mesa waveguide M2 are connected to each other. In this embodiment, first semiconductor layer 14 of first mesa waveguide M1 and first semiconductor layer 14 of second mesa waveguide M2 are connected to each other to form a single semiconductor layer. First semiconductor layer 14 may not include the pair of second portions 14b. In this instance, first semiconductor layer 14 of first mesa waveguide M1 and first semiconductor layer 14 of second mesa waveguide M2 can be electrically connected to each other by a semiconductor layer or a conductive layer which are provided between substrate 12 and first semiconductor layer 14.

First semiconductor layer 14 includes a III-V group compound semiconductor doped with a p-type dopant. First semiconductor layer 14 includes zinc (Zn)-doped InGaAs or Zn-doped InP, for example. First semiconductor layer 14 has a dopant concentration greater than a dopant concentration in second semiconductor layer 16. The dopant concentration in first semiconductor layer 14 may be ten times or more of the dopant concentration in second semiconductor layer 16. The dopant concentration in first semiconductor layer 14 may be 5×10¹⁸ cm⁻³ or more, or may be 1×10¹⁹ cm⁻³ or more. A thickness T1 of first semiconductor layer 14 is 0.5 μm or more and 2.0 μm or less, for example.

Second semiconductor layer 16 includes a first portion 16a and a pair of second portions 16b. First portion 16a is located between core layer 18 and first semiconductor layer 14. Each of the pair of second portions 16b is located on each side of first portion 16a. A thickness of first portion 16a is greater than a thickness of second portion 16b. First portion 16a and the pair of second portions 16b extend in the X-axis direction. Thus, a width of second semiconductor layer 16 is greater than a width of core layer 18. Second semiconductor layer 16 of first mesa waveguide M1 and second semiconductor layer 16 of second mesa waveguide M2 are connected to each other. In this embodiment, second semiconductor layer 16 of first mesa waveguide M1 and second semiconductor layer 16 of second mesa waveguide M2 are connected to each other to form a single semiconductor layer. Second semiconductor layer 16 may not include the pair of second portions 16b.

Second semiconductor layer 16 includes a III-V group compound semiconductor doped with a p-type dopant. Second semiconductor layer 16 may include a semiconductor material different from the semiconductor material of first semiconductor layer 14. Second semiconductor layer 16 includes Zn-doped InP, for example. A dopant concentration in second semiconductor layer 16 may be 5×10¹⁷ cm⁻³ or more and 2×10¹⁸ cm⁻³ or less. A thickness T2 of second semiconductor layer 16 (a thickness of first portion 16a) may be greater than a thickness T1 of first semiconductor layer 14. The thickness T2 of second semiconductor layer 16 is 1.0 μm or more and 3.0 μm or less, for example.

Core layer 18 is an i-type semiconductor layer, that is, an undoped semiconductor layer. Core layer 18 may have a multi quantum well structure. Core layer 18 includes AlGaInAs-based III-V group compound semiconductors, for example. A width of core layer 18 is 1.5 μm or less, for example.

Third semiconductor layer 20 includes a III-V group compound semiconductor doped with an n-type dopant. Third semiconductor layer 20 includes Si-doped InP, for example. A dopant concentration in third semiconductor layer 20 may be 5×10¹⁷ cm⁻³ or more and 2×10¹⁸ cm⁻³ or less. A thickness of third semiconductor layer 20 is 1.0 μm or more and 3.0 μm or less, for example.

Each of first mesa waveguide M1 and second mesa waveguide M2 may include an n-type fourth semiconductor layer 22 provided on third semiconductor layer 20. Fourth semiconductor layer 22 includes a III-V group compound semiconductor doped with an n-type dopant. Fourth semiconductor layer 22 may include a semiconductor material that differs from the semiconductor material of third semiconductor layer 20. Fourth semiconductor layer 22 includes Si-doped InGaAs or Si-doped InP, for example. Fourth semiconductor layer 22 has a dopant concentration greater than the dopant concentration of third semiconductor layer 20. The dopant concentration in fourth semiconductor layer 22 may be 5×10¹⁸ cm⁻³ or more, or may be 1×10¹⁹ cm⁻³ or more. A thickness of fourth semiconductor layer 22 is 0.1 μm or more and 0.5 μm or less, for example.

An electrode E1 is connected to fourth semiconductor layer 22 of first mesa waveguide M1. Electrode E1 is in ohmic contact with fourth semiconductor layer 22. Electrode E1 is connected to conductive line E1a. Similarly, an electrode E2 is connected to fourth semiconductor layer 22 of second mesa waveguide M2. Electrode E2 is in ohmic contact with fourth semiconductor layer 22. Electrode E2 is connected to conductive line E2a. Each of electrode E1 and electrode E2 includes a Ni layer, a Ge layer, and an Au layer, for example. Further electrodes may be connected to first semiconductor layer 14.

An insulating film 30 containing, for example, inorganic materials may be provided on main surface 12a of substrate12, the side surfaces of first mesa waveguide M1, and the side surfaces of second mesa waveguide M2. An embedding region 32 may be provided on insulating film 30 so as to embed first mesa waveguide M1 and second mesa waveguide M2. Embedding region 32 includes resin, for example. Insulating film 30 may be provided on embedding region 32.

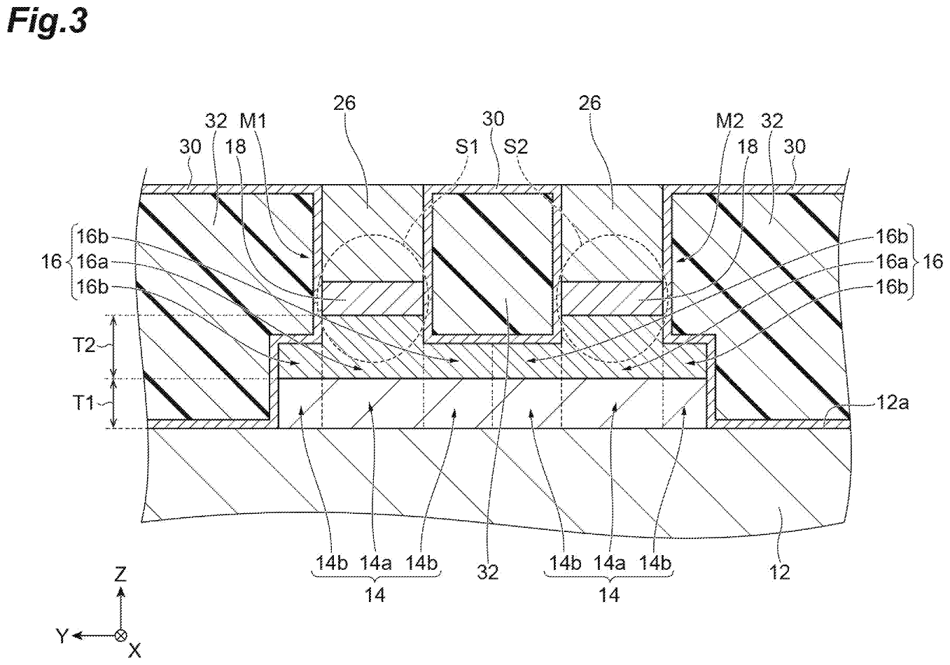

FIG. 3 is a cross-sectional view taken along line III-III in FIG. 1. FIG. 3 illustrates cross-sections of insulating portion M1s and insulating portion M2s. As illustrated in FIG. 3, in insulating portion M1s and insulating portion M2s, each of first mesa waveguide M1 and second mesa waveguide M2 includes no third semiconductor layer 20 and no fourth semiconductor layer 22, but includes a semi-insulating semiconductor layer 26 provided on core layer 18. Electrode E1, electrode E2, conductive line E1a and conductive line E2a are not provided on semi-insulating semiconductor layer 26. Semi-insulating semiconductor layer 26 includes a III-V group compound semiconductor doped with an insulating dopant. Semi-insulating semiconductor layer 26 includes Fe-doped InP, for example.

In optical modulator 10 of the present embodiment, AC voltages are applied to electrode E1 and electrode E2 by driver circuit DR. For example, a voltage is applied to first mesa waveguide M1 to adjust the intensity or phase of a light propagating through core layer 18 of first mesa waveguide M1. Similarly, a voltage is applied to second mesa waveguide M2 to adjust the intensity or phase of a light propagating through core layer 18 of second mesa waveguide M2. In optical modulator 10, since first semiconductor layer 14 has a resistance value smaller than a resistance value of second semiconductor layer 16, the total resistance value of first semiconductor layer 14 and second semiconductor layer 16 can be reduced as compared with the case where first semiconductor layer 14 does not exist and only second semiconductor layer 16 is used. As a result, the resistance value of each of first mesa waveguide M1 and second mesa waveguide M2 is lowered, so that modulation bandwidth of optical modulator 10 can be widened. On the other hand, since second semiconductor layer 16 has an optical absorption coefficient smaller than an optical absorption coefficient of first semiconductor layer 14, a transmission loss of the light propagating through core layer 18 can be reduced as compared with the case where second semiconductor layer 16 does not exist and only first semiconductor layer 14 is used. Therefore, according to optical modulator 10, it is possible to reduce the transmission loss of the light propagating through core layer 18 while reducing the resistance value of each of first mesa waveguide M1 and second mesa waveguide M2.

When first semiconductor layer 14 of first mesa waveguide M1 and first semiconductor layer 14 of second mesa waveguide M2 are connected to each other, first mesa waveguide M1 and second mesa waveguide M2 can be connected to each other. As a result, a connection resistance between first mesa waveguide M1 and second mesa waveguide M2 can be reduced. When second semiconductor layer 16 of first mesa waveguide M1 and second semiconductor layer 16 of second mesa waveguide M2 are connected to each other, the connection resistance between first mesa waveguide M1 and second mesa waveguide M2 can be further reduced. Further, when each width of first semiconductor layer 14 and second semiconductor layer 16 is larger than the width of core layer 18, each resistance value of first semiconductor layer 14 and second semiconductor layer 16 can be reduced.

When first semiconductor layer 14 contains InGaAs, the dopant concentration of first semiconductor layer 14 can be made higher than that in the case where first semiconductor layer 14 contains InP.

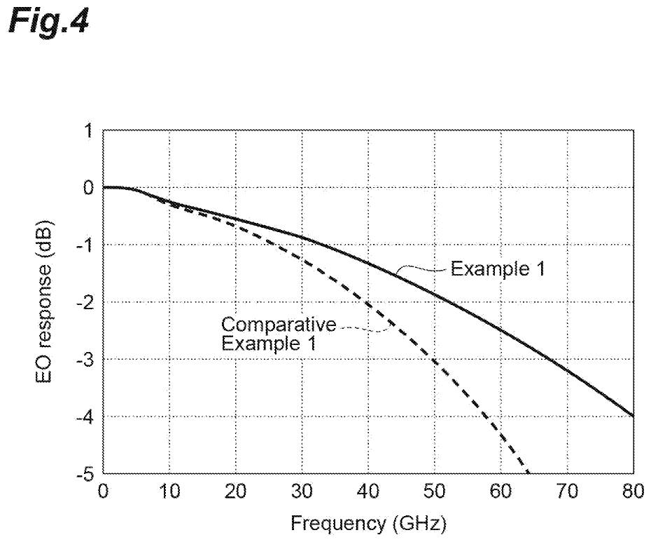

FIG. 4 is a graphical representation of an exemplary relation between frequency and electro-optical (EO) response. The horizontal axis in FIG. 4 represents a frequency (GHz). The vertical axis in FIG. 4 represents an EO response (dB). FIG. 4 illustrates the results of simulations of EO response characteristics in the optical modulators of Example 1 and Comparative Example 1.

The optical modulator of Example 1 has the n-i-p structure illustrated in FIGS. 1 to 3. The optical modulator of Example 1 has the following configurations.

Substrate 12: Fe-doped InP substrate (Fe-concentration: 1×10¹⁷ cm⁻³ or more and 1×10¹⁸ cm⁻³ or less).

First semiconductor layer 14: Zn-doped InGaAs layer (thickness: 1 μm, Zn-concentration: 1×10¹⁹ cm⁻³ or more).

Second semiconductor layer 16: Zn-doped InP layers (thickness of first portion 16a: 1.5 μm, thickness of second portion 16b: 1 μm, Zn-concentration: 5×10¹⁷ cm⁻³ or more and 2×10¹⁸ cm⁻³ or less).

Core layer 18: AlGaInAs-based multiple quantum wells (thickness: 0.5 μm, width: 1.5 μm, distance between core layer 18 of first mesa waveguide M1 and core layer 18 of second mesa waveguide M2: 15 μm).

Third semiconductor layer 20: Si-doped InP layer (Si-concentration: 5×10¹⁷ cm⁻³ or more and 2×10¹⁸ cm⁻³ or less).

Fourth semiconductor layer 22: Si-doped InGaAs layer (Si-concentration: 1×10¹⁹ cm⁻³ or more).

Electrode E1 and electrode E2: Ni/Ge/Au (total thickness of third semiconductor layer 20, fourth semiconductor layer 22 and electrode E1 (electrode E2): 1.5 μm).

Conductive line E1a and conductive line E2a: Au layer (thickness: 2 μm, width: 4 μm, length: 120 μm).

Electrode pad EP1 and electrode pad EP2: Au layer (width: 50 μm, distance between electrode pad EP1 and electrode pad EP2 in the Y-axis direction: 50 μm, length in the X-axis direction of the part corresponding to one modulation portion M1m and one insulating portion M1s: 150 μm).

Semi-insulating semiconductor layer 26: Fe-doped InP layer (Fe-concentration: 1×10¹⁷ cm⁻³ or more and 1×10¹⁸ cm⁻³ or less).

The optical modulator of Comparative Example 1 has a p-i-n structure. The optical modulator of Comparative Example 1 has the same configuration as that of Example 1 except for the followings. The optical modulator of Comparative Example 1 includes an n-type Si-doped InP layer instead of first semiconductor layer 14 and second semiconductor layer 16. The optical modulator of Comparative Example 1 includes a p-type Zn-doped InP layer and a p-type Zn-doped InGaAs layer instead of third semiconductor layer 20. The optical modulator of Comparative Example 1 includes Ti/Pt/Au as electrode E1 and electrode E2. The optical modulator of Comparative Example 1 includes an undoped InP layer instead of semi-insulating semiconductor layer 26. Therefore, the optical modulator of Comparative Example 1 has the following configurations.

Substrate 12: Fe-doped InP substrate (Fe-concentration: 1×10¹⁷ cm⁻³ or more and 1×10¹⁸ cm⁻³ or less).

N-type InP layer: Si-doped InP layer (thickness of a portion corresponding to first portion 16a: 1.5 μm, thickness of a portion corresponding to second portion 16b: 1 μm, Si-concentration: 5×10¹⁷ cm⁻³ or more and 2×10¹⁸ cm⁻³ or less).

Core layer 18: AlGaInAs-based multi quantum wells (thickness: 0.5 μm, width: 1.5 μm, distance between core layer 18 of first mesa waveguide M1 and core layer 18 of second mesa waveguide M2: 15 μm).

P-type InP layer: Zn-doped InP layer (Zn-concentration: more than 1×10¹⁹ cm⁻³).

P-type InGaAs layer: Zn-doped InGaAs layer (Zn-concentration: 1×10¹⁹ cm⁻³ or more).

Electrode E1 and electrode E2: Ti/Pt/Au (total thickness of p-type InP layer, p-type InGaAs layer and electrode E1 (electrode E2): 1.5 μm).

Conductive line E1a and conductive line E2a: Au layer (thickness: 2 μm, width: 4 μm, length: 120 μm).

Electrode pad EP1 and electrode pad EP2: Au layer (width: 50 μm, distance between electrode pad EP1 and electrode pad EP2 in the Y-axis direction: 50 μm, length in the X-axis direction of the part corresponding to one modulation portions M1m and one insulating portion M1s: 150 μm).

Undoped InP layer: undoped InP layer.

As illustrated in FIG. 4, the optical modulator of Comparative Example 1 has a 3 dB-bandwidth of 50 GHz. On the other hand, the optical modulator of Example 1 has a 3 dB-bandwidth of 67.5 GHz. Therefore, it can be seen that the modulation bandwidth of the optical modulator of Example 1 is wider than that of the optical modulator of Comparative Example 1.

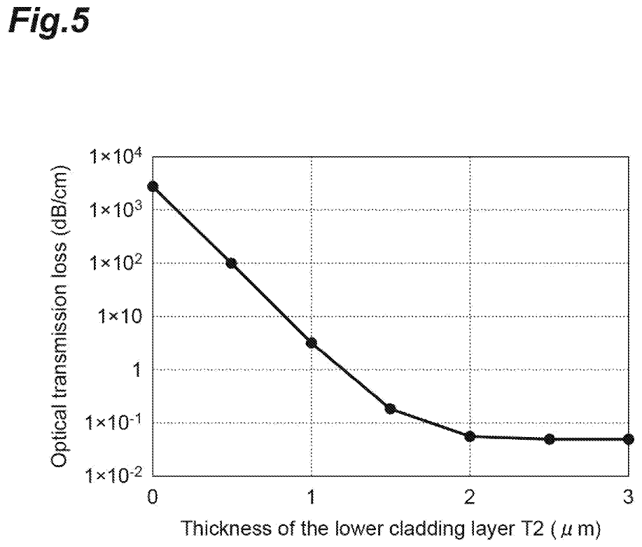

FIG. 5 is a graphical representation of an exemplary relation between lower cladding layer and optical transmission loss. The horizontal axis in FIG. 5 represents a thickness T2 (μm) of the lower cladding layer. The vertical axis of FIG. 5 represents an optical transmission loss (dB/cm). FIG. 5 illustrates the results of simulations in optical modulators of Experiments 1 to 7. The optical modulators of Experiments 1 to 7 have the same configurations except that the thicknesses T2 of second semiconductor layers 16, which are lower cladding layers, are different from each other. For example, in the optical modulator of Experiment 1, the thickness T2 of second semiconductor layer 16 is 0 μm. That is, there is no second semiconductor layer 16. In the optical modulators of Experiments 2 to 7, the respective thicknesses T2 of second semiconductor layers 16 are 0.5 μm, 1 μm, 1.5 μin, 2 μin, 2.5 μm, and 3 μm in this order. The optical modulator of Experiment 4 in which the thickness T2 of second semiconductor layer 16 is 1.5 μm corresponds to the optical modulator of Example 1 illustrated in FIG. 4.

As illustrated in FIG. 5, as the thickness T2 of second semiconductor layer 16 increases, optical transmission loss becomes small. When the thickness T2 of second semiconductor layer 16 is 1.4 μm or more, the optical transmission loss is 1 dB/cm or less.

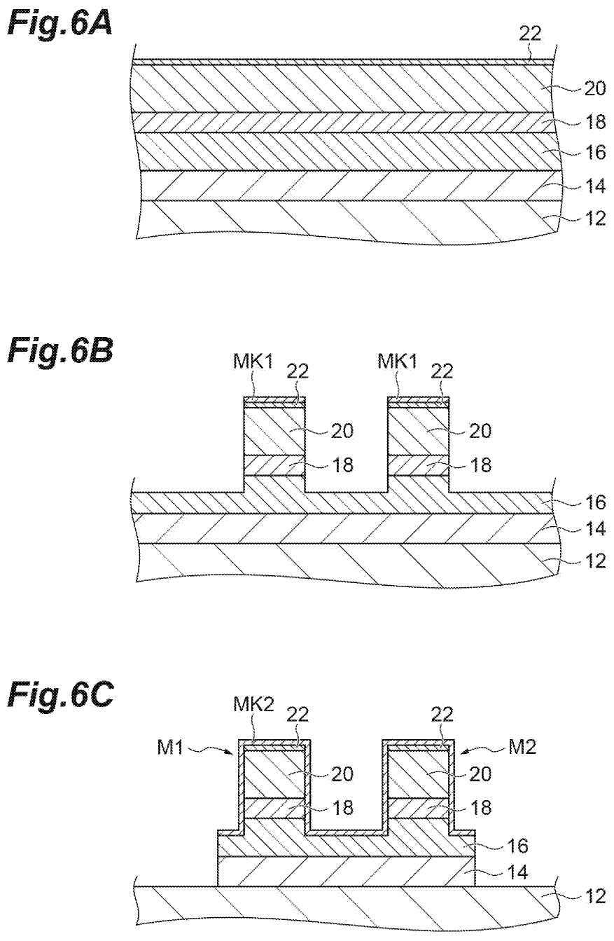

FIGS. 6A to 6C are cross-sectional views schematically illustrating steps in a method of manufacturing the optical modulator according to the first embodiment. Optical modulator 10 may be manufactured as follows.

First, as illustrated in FIG. 6A, a first semiconductor layer 14, a second semiconductor layer 16, a core layer 18, a third semiconductor layer 20 and a fourth semiconductor layer 22 are formed in order on a substrate 12 by an organometallic vapor phase epitaxy, for example. Thereafter, for example, by photolithography and dry etching, third semiconductor layer 20 and fourth semiconductor layer 22 which are located in areas for forming insulating portions M1s illustrated in FIG. 1 are etched using masks. Subsequently, semi-insulating semiconductor layer 26 in FIG. 3 is formed on the areas for forming insulating portions M1s by an organometallic vapor phase epitaxy, for example. Thereafter, the masks are removed by wet etching, for example.

Second semiconductor layer 16, core layer 18, third semiconductor layer 20 and fourth semiconductor layer 22 are then etched using masks MK1, for example, by photolithography and dry etching, as shown in FIG. 6B. Second semiconductor layer 16 and first semiconductor layer 14 are then etched using masks MK2, for example, by photolithography and dry etching, as illustrated in FIG. 6C. Thus, a first mesa waveguide M1 and a second mesa waveguide M2 are formed.

Next, an insulating film 30 is formed so as to cover first mesa waveguide M1 and second mesa waveguide M2 as illustrated in FIG. 2. Thereafter, embedding region 32 is formed by coating resin on insulating film 30. Thereafter, insulating film 30 is formed on embedding region 32. Subsequently, an electrode E1, an electrode E2, a conductive line E1a, a conductive line E2a, a conductive line E1b, a conductive line E2b, an electrode pad EP1 and an electrode pad EP2 are formed by photolithography, dry etching, evaporation, and lift-off, for example.

### Second Embodiment

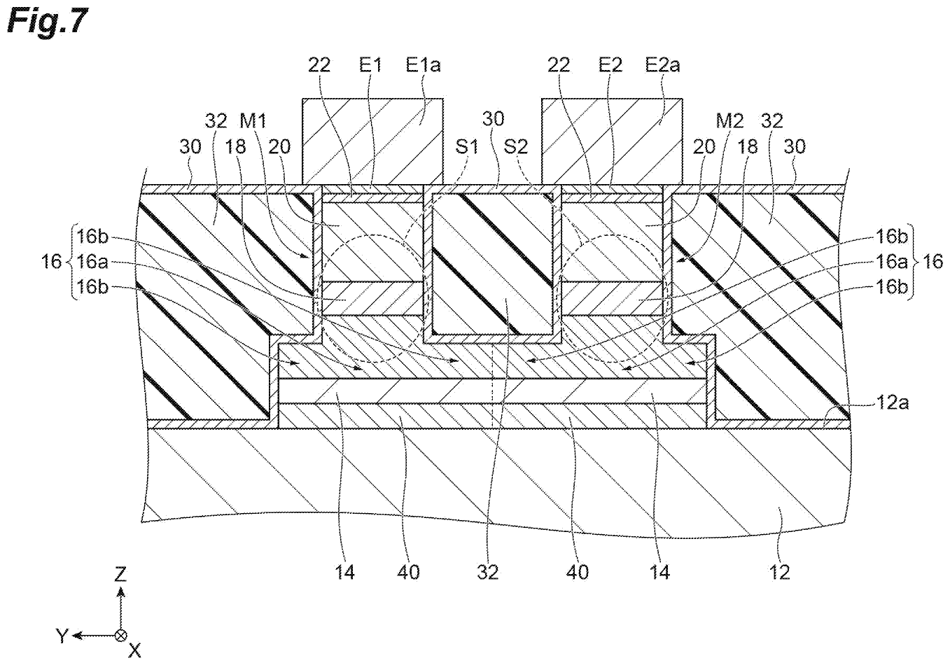

FIG. 7 is a cross-sectional view schematically illustrating a part of an optical modulator according to a second embodiment. An optical modulator illustrated in FIG. 7 has the same configuration as the optical modulator 10 of the first embodiment except that it further includes a barrier layer 40. In the optical modulator illustrated in FIG. 7, each of a first mesa waveguide M1 and a second mesa waveguide M2 further includes a barrier layer 40 provided between a substrate 12 and a first semiconductor layer 14.

Barrier layer 40 may prevent a dopant contained in first semiconductor layer 14 from diffusing into substrate 12 in a step of forming semiconductor layers by an organometallic vapor phase epitaxy or in a step of forming electrodes. Barrier layer 40 may prevent a dopant contained in substrate 12 from diffusing into first semiconductor layer 14. Fe dopant of substrate 12 and Zn dopant of first semiconductor layer 14 particularly tend to diffuse. When the interface between substrate 12 and first semiconductor layer 14 is at high temperatures, interdiffusion between Fe and Zn tends to occur. When Zn diffused from first semiconductor layer 14 enters substrate 12, semi-insulating property of substrate 12 deteriorates. When Fe diffused from substrate 12 enters first semiconductor layer 14, a resistance of first semiconductor layer 14 rises and EO response characteristics deteriorates. By providing thicker barrier layer 40 than a diffusion length of Fe or Zn at a growth temperature during organometallic vapor phase epitaxy, the diffusion of Fe terminates within barrier layer 40, and Fe is suppressed from reaching first semiconductor layer 14. Barrier layer 40 suppresses Zn from reaching substrate 12. Barrier layer 40 of first mesa waveguide M1 and barrier layer 40 of second mesa waveguide M2 are connected to each other. In this embodiment, barrier layer 40 of first mesa waveguide M1 and barrier layer 40 of second mesa waveguide M2 are connected to each other to form a single semiconductor layer.

Barrier layer 40 may be an undoped semiconductor layer (i-type semiconductor layer), may be an n-type semiconductor layer, or may be a semiconductor layer containing both an insulating dopant (for example, Fe) and an n-type dopant (for example, Si). Barrier layer 40 includes III-V group compound semiconductors such as InP, AlInAs, AlInAsP, InGaAsP, and the like. A thickness of barrier layer 40 is, 0.1 μm or more and 3.0 μm or less, for example.

In the second embodiment, the same effects as in the first embodiment are obtained. Further, barrier layer 40 can suppress the decreases in the respective dopant concentrations of substratel2 and first semiconductor layer 14.

The preferred embodiments of the present disclosure have been described in detail above. However, the present disclosure is not limited to the above embodiments. Each component of each embodiment may be arbitrarily combined.

While the principles of the present invention have been illustrated and described in preferred embodiments, it will be appreciated by those skilled in the art that the invention may be modified in arrangement and detail without departing from such principles. The present invention is not limited to the specific configurations disclosed in this embodiment. Accordingly, it is claimed that all modifications and changes come from the scope of the claims and their spirit.

What is claimed is:

1. An optical modulator comprising:
a first mesa waveguide and a second mesa waveguide,
the first mesa waveguide and the second mesa waveguide each including a first semiconductor layer having a p-type conductivity, a second semiconductor layer having a p-type conductivity, a core layer provided on the second semiconductor layer, and a third semiconductor layer having an n-type conductivity, the first semiconductor layer being provided on a substrate, the second semiconductor layer being provided on the first semiconductor layer, the third semiconductor layer being provided on the core layer, and
the first semiconductor layer having a dopant concentration greater than a dopant concentration in the second semiconductor layer.

2. The optical modulator according to claim 1, wherein the first semiconductor layer of the first mesa waveguide and the first semiconductor layer of the second mesa waveguide are connected to each other.

3. The optical modulator according to claim 1, wherein each of the first mesa waveguide and the second mesa waveguide includes a barrier layer provided between the substrate and the first semiconductor layer, wherein the barrier layer prevents a dopant contained in the first semiconductor layer from diffusing into the substrate.

4. The optical modulator according to claim 3, wherein the substrate is a semi-insulating semiconductor substrate, wherein the barrier layer prevents a dopant contained in the substrate from diffusing into the first semiconductor layer.

5. The optical modulator according to claim 1, wherein the first semiconductor layer includes InGaAs.

6. The optical modulator according to claim 1, wherein the dopant concentration in first semiconductor layer is ten times or more of the dopant concentration in second semiconductor layer.

7. The optical modulator according to claim 6, wherein the dopant concentration in first semiconductor layer is 5×10¹⁸ cm⁻³ or more.

8. The optical modulator according to claim 1, wherein the semiconductor layer includes a semiconductor material different from a semiconductor material of first semiconductor layer.

9. The optical modulator according to claim 1, wherein a thickness of the second semiconductor layer is greater than a thickness of the first semiconductor layer.

10. The optical modulator according to claim 1, wherein a thickness of the second semiconductor layer is 1.4 μm or more.
